(19) United States
(12) Patent Application Publication
(10) Pub. No.: US 2013/0044472 A1
(43) Pub. Date: Feb. 21, 2013

(54) LIGHT-EMITTING DEVICE FOR BACKLIGHT SOURCE

(71) Applicant: JIAN-SHIHN TSANG, Tu-Cheng (TW)

(72) Inventor: JIAN-SHIHN TSANG, Tu-Cheng (TW)

(73) Assignee: HON HAI PRECISION INDUSTRY CO., LTD., Tu-Cheng (TW)

(21) Appl. No.: 13/304,417

(22) Filed: Nov. 25, 2011

(30) Foreign Application Priority Data
Aug. 18, 2011 (TW) 100129495

(51) Int. Cl. F21V 9/00; F21V 29/00

(52) U.S. Cl. 362/231

(57) ABSTRACT

A light-emitting device includes a substrate, a first light-emitting member and a second light-emitting member mounted on the substrate. The first light-emitting member emits first light having a first color temperature. The second light-emitting member emits second light having a second color temperature. The second color temperature is higher than the first color temperature. The first light mixes with the second light making the light-emitting device to produce a light having a wider range of color temperature.

### BACKGROUND

1. Technical Field

The present disclosure generally relates to light-emitting devices, and particularly to a light-emitting device for a backlight source.

2. Description of Related Art

With developments in semiconductor technology, LEDs (light emitting diodes), which are new generation light-emitting devices, are widely used as backlight sources of the liquid crystal displays instead of the CCFLs (cold cathode fluorescent lamps) due to their high light-emitting efficiencies, high brightness and long lifespan.

Nowadays, manufacturing technologies for the LEDs for household illumination are mature. However, a color temperature of such LEDs through existed manufacturing technologies is only ranged from 2300K to 9000K, which cannot meet a backlight requirement that a color temperature of backlight source must be ranged from 8000K to 15000K.

What is needed, therefore, is a light-emitting device which can overcome the limitations described.

### BRIEF DESCRIPTION OF THE DRAWINGS

FIG. 1 is a top view of a light-emitting device in accordance with a first embodiment of the present disclosure.

FIG. 2 is a cross-sectional view of the light-emitting device of FIG. 1, taken along line II-II thereof.

FIG. 3 is a top view of a light-emitting device in accordance with a second embodiment of the present disclosure.

FIG. 4 is a cross-sectional view of a light-emitting device in accordance with a third embodiment of the present disclosure.

FIG. 5 is a top view of a light-emitting device in accordance with a fourth embodiment of the present disclosure.

FIG. 6 is a top view of a light-emitting device in accordance with a fifth embodiment of the present disclosure.

### DETAILED DESCRIPTION

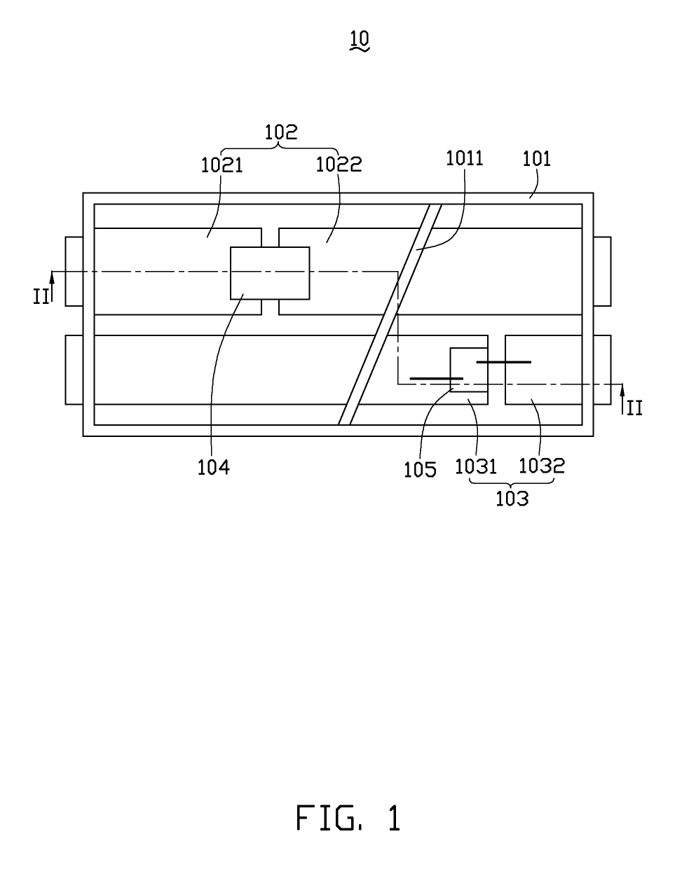

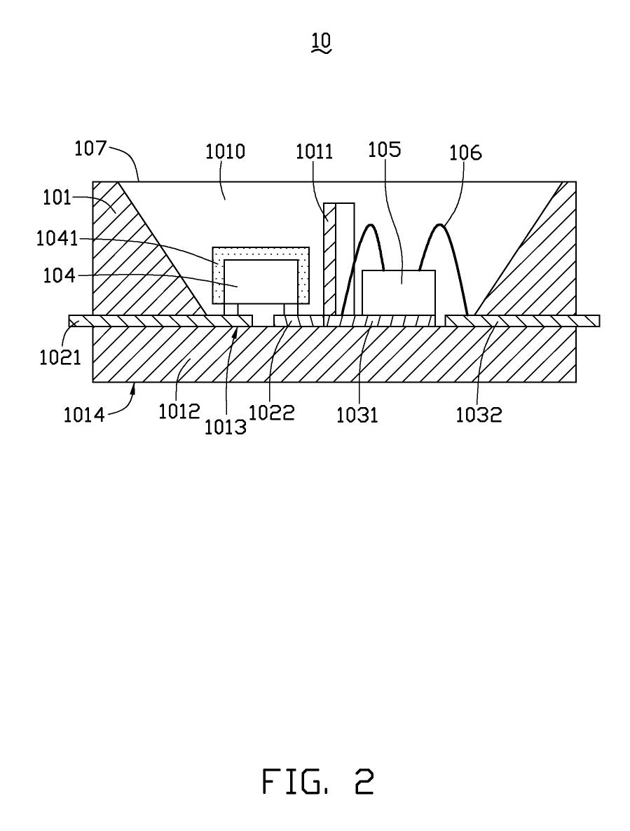

Referring to FIGS. 1-2, a light-emitting device 10 in accordance with a first embodiment of the present disclosure is shown. The light-emitting device 10 includes a reflector 101, a substrate 1012, two electric assemblies 102, 103, a first light-emitting member 104, a second light-emitting member 105, two conductive wires 106 and an encapsulant 107.

The substrate 1012 includes a first surface 1013 and a second surface 1014 opposite to the first surface 1013. The two electric assemblies 102, 103 are mounted on the first surface 1013 of the substrate 1012 and insulative from each other. The two electric assemblies 102, 103 each include a first electrode 1021, 1031 and a second electrode 1022, 1032. The first light-emitting member 104 is mounted on the electric assembly 102, and the second light-emitting member 105 is mounted on the electric assembly 103.

The first light-emitting member 104 is a blue LED chip cooperating with a first phosphor layer 1041, so as to emit white light having a first color temperature ranged from 2300K to 9000K. Two electrodes (not labeled) of the first light-emitting member 104 are respectively connected to the first electrode 1021 and the second electrode 1022 of the electric assembly 102 through flip chip bonding. The second light-emitting member 105 is a blue LED to emit blue-colored light having a second color temperature ranged from 9000K to 20000K and a wavelength ranged from 420 nm to 470 nm. A preferred wavelength of the blue-colored light of the second light-emitting member 105 is ranged from 430 nm to 460 nm. The blue LED chip of the second light-emitting member 105 is made of semiconductor such as SiC, ZnO, AlGaInN, MgZnSeS et al. A preferred semiconductor for the blue LED chip is AlGaInN. In other embodiment, the second light-emitting member 105 can be a green LED chip, a violet LED chip or an ultraviolet LED chip having a relative short wavelength cooperating with a second phosphor, such as yellow phosphor, blue phosphor, yellow-green phosphor, et al. The second light-emitting member 105 is connected to the electric assembly 103 through wire bonding. The second light-emitting member 105 is located on the first electrode 1031 of the electric assembly 103. Two electrodes of the second light-emitting member 105 are electrically connected with the first electrode 1031 and the second electrode 1032 of the electric assembly 103 through two wires 106. The two electric assemblies 102, 103 are supplied with different currents to drive the first light-emitting member 104 and the second light-emitting member 105 to emit different light with different color temperatures.

The reflector 101 is mounted on the substrate 1012 and surrounds the first light-emitting member 104 and the second light-emitting member 105, reflecting the light of the first light-emitting member 104 and the second light-emitting member 105. The reflector defines a chamber 1010 therein. The first light-emitting member 104 and the second light-emitting member 105 are received in the chamber 1010. Two end tips of each of the two electric assemblies 102, 103 protrude out from the reflector 101, facilitating the two electric assemblies 102, 103 to connect with a power supply (not shown). A clapboard 1011 is mounted in the chamber 1010 of the reflector 101. A top edge of the clapboard 1011 is below a top level of the reflector 101. The reflector 101 and the clapboard 1011 are made of materials with good light reflecting ability. The clapboard 1011 divides the chamber 1010 of the reflector 101 into two sub-chambers respectively receiving the first light-emitting member 104 and the second light-emitting member 105 therein. The chamber 1010 of the reflector 101 is filled with the encapsulant 107. The encapsulant 107 covers on the first light-emitting member 104 and the second light-emitting member 105.

During working of the light-emitting device 10, the first light-emitting member 104 emits the white light having a first color temperature ranged from 2300K to 9000K, and the second light-emitting member 105 emits the blue light having a second color temperature ranged from 9000K to 20000K. The blue light having higher color temperature mixes with the white light having lower color temperature, whereby the light from the light-emitting device 10 can have a wider range of color temperature. In other words, high color temperature of the second light-emitting member 105 compensates the low color temperature of the first light-emitting member 104, making the light-emitting device 10 meet the requirement of the liquid crystal display backlight source regarding color temperature.

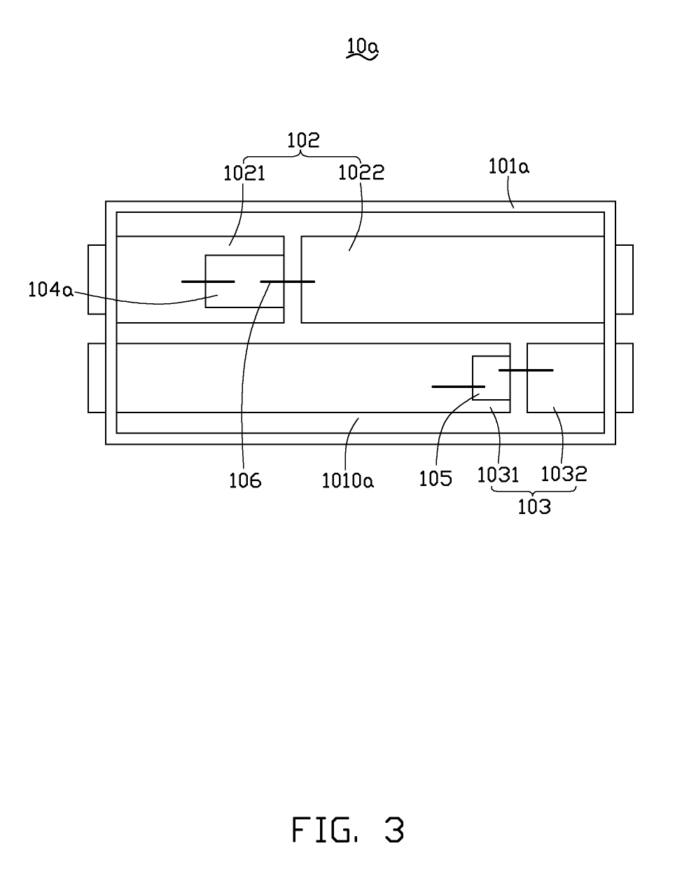

In the first embodiment, the first light-emitting member 104 and the second light-emitting member 105 are separated by the clapboard 1011, but in other embodiment the clapboard 1011 can be omitted, as shown in FIG. 3, a light-emitting device 10a in accordance with a second embodiment of the present disclosure is shown. The light-emitting device 10a which is similar with the light-emitting device 10 in the first embodiment only differs in that, a chamber 1010a of the reflector 101a is integral and undivided, and the first light-emitting member 104a is mounted on the electric assembly 102 also through wire bonding. The first light-emitting member 104a is placed on the first electrode 1021 of electric plate 102. Two electrodes of the first light-emitting member 104a are respectively connected to the first and second electrodes 1021, 1022 through two wires 106.

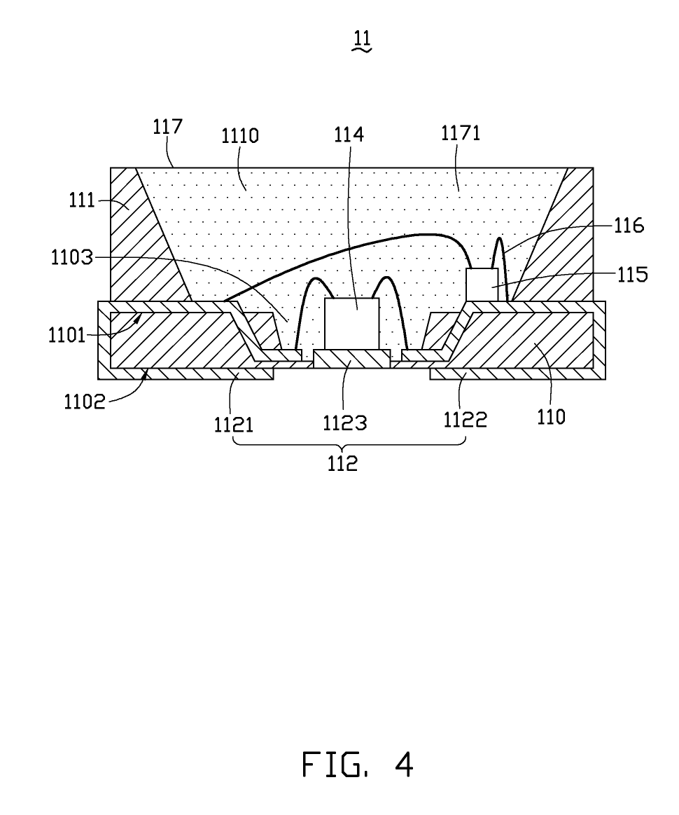

Referring to FIG. 4, a light-emitting device 11 in accordance with a third embodiment of the present disclosure is shown. The light-emitting device 11 includes a substrate 110, a reflector 111, an electric assembly 112, a first light-emitting member 114, a second light-emitting member 115, a plurality of wires 116 and an encapsulant 117. The substrate 110 includes a first surface 1101 and a second surface 1102 opposite each other. The substrate 110 defines a concave 1103 in a middle portion of the first surface 1101. The electric assembly 112 includes a first electrode 1121 and a second electrode 1122, and a heat conductive block 1123. The first electrode 1121, the second electrode 1122 and the heat conductive block 1123 are electrically insulated from each other. The heat conductive block 1123 is embedded in a bottom of the concave 1103. The first light-emitting member 104 is mounted on the heat conductive block 1123. The first electrode 1121 and the second electrode 1122 are symmetrical with each other relative to the first light-emitting member 114 and located at two lateral sides of the first light-emitting member 114, respectively. Each of the first electrode 1121 and the second electrode 1122 extends from the bottom of the concave 1103 to the second surface 1102 of the substrate 110 via the first surface 1101 and a lateral side of the substrate 110. Two electrodes of the first light-emitting member 114 are respectively connected to the first electrode 1121 and the second electrode 1122 of the electric assembly 112 through two wires 116. The second light-emitting member 115 is placed on a portion of the second electrode 1122 of the electric assembly 112 adhered to the first surface 1101 of the substrate 110, and two electrodes of the second light-emitting member 115 are respectively connected to the first electrode 1121 and the second electrode 1122 of the electric assembly 112 through other two wires 116. The second light-emitting member 115 is located at a level higher than that of the first light-emitting member 114, in respect of the second surface 1102 of the substrate 110. When the electric assembly 112 is supplied with electrical power, the first light-emitting member 114 and the second light-emitting member 115 emit light simultaneously.

The reflector 111 is mounted on the substrate 110 and surrounds the first light-emitting member 114 and the second light-emitting member 115, reflecting the light of the first light-emitting member 114 and the second light-emitting member 115. The reflector 111 defines a chamber 1110 therein. The first light-emitting member 114 and the second light-emitting member 115 are received in the chamber 1110. The encapsulant 117 is received in the chamber 1110 and covers the first light-emitting member 114 and the second light-emitting member 115. The encapsulant 117 is doped with fluorescence 1171. One of the first and the second light-emitting members 114, 115 can be chosen as to have color temperature higher than that of the other one of the first and the second light-emitting members 114, 115. In this embodiment, the second light-emitting member 115 is a blue LED which has a higher color temperature than the that of the first light-emitting member 114 which emits white light.

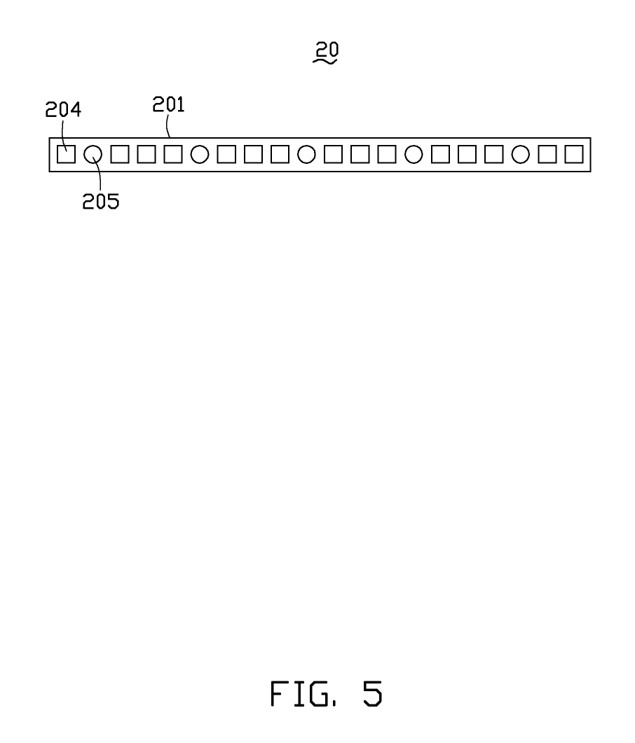

Referring to FIG. 5, a light-emitting device 20 in accordance with a fourth embodiment of the present disclosure is shown. The light-emitting device 20 is a light bar. The light-emitting device 20 includes a substrate 201, a plurality of first light-emitting members 204 and a plurality of second light-emitting members 205 mounted on the substrate 201. The substrate 201 is strip-shaped. The first light-emitting members 204 and the second light-emitting members 205 are arranged on the substrate 201 in a line. Each of the first light-emitting members 204 is a blue LED chip cooperating with a first phosphor layer. Each of the second light-emitting members 205 is a blue LED chip or a blue LED chip cooperating with a second phosphor layer. A color temperature of the second light-emitting member 205 is higher than that of the first light-emitting member 204. There are three first light-emitting members 204 between every two adjacent second light-emitting members 205. In other words, every second light-emitting member 205 is alternate with three first light-emitting members 204. Generally, different currents cause different light intensities. Thus a ratio between a number of the first light-emitting member 204 and the second light-emitting member 205 is variable. A preferred ratio between the number of the first light-emitting member 204 and the second light-emitting member 205 is ranged from 1:20 to 20:1. During working of the light-emitting device 20, the light having higher color temperature emitted by the second light-emitting member 205 compensates the light having lower color temperature emitted by the first light-emitting device 204, making the light-emitting device 20 meet the requirement of the crystal display backlight source regarding color temperature.

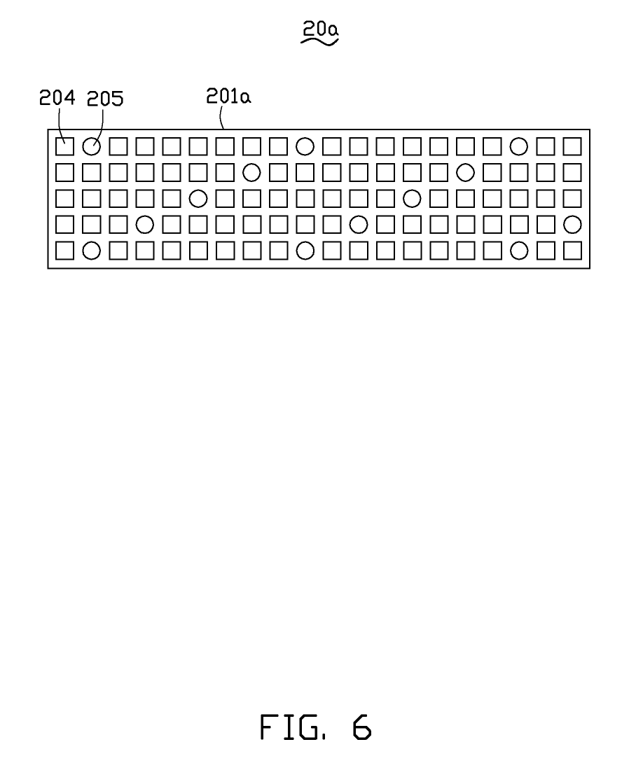

Referring to FIG. 6, a light-emitting device 20a in accordance with a fifth embodiment of the present disclosure is shown. The light-emitting device 20a is a light array. The second light-emitting device 20 includes a substrate 201a, a plurality of first light-emitting members 204 and a plurality of second light-emitting members 205 mounted on the substrate 201a. The substrate 201a is rectangular. The first light-emitting members 204 and the second light-emitting members 205 are arranged on the substrate 201a in a plurality of rows and columns. The first and second light-emitting members 204, 205 arranged according to a specific pattern. In the embodiment shown in FIG. 6, there are five rows and in each row there are seven first light-emitting members 204 between every two adjacent second light-emitting members 205, while the two adjacent second light-emitting members in the uppermost row are vertically aligned with the two adjacent second light-emitting members in the lowermost row. Between the two adjacent second light-emitting members 205 at the uppermost row or at the lowermost row, a second light-emitting member 205 is located at every two columns counted from either of the columns where the two adjacent second light-emitting members 205 are located. The second light emitting-members 205 between the two adjacent second light-emitting members 205 at the uppermost row or the lowermost row are at different levels, wherein they are gradually increased in level along a left-to-right direction of FIG. 6 (i.e., a right one being higher a row than an immediate left one). Each of the first light-emitting members 204 is a blue LED chip cooperating with a first phosphor layer. Each of the second light-emitting members 205 is a blue LED chip or a blue LED chip cooperating with a second phosphor layer. A color temperature of the first light-emitting member 204 is less than that of the second light-emitting member 205. A preferred ratio between number of the first light-emitting member 204 and the second light-emitting member 205 in each row is ranged from 1:20 to 20:1.

It is to be understood, however, that even though numerous characteristics and advantages of the exemplary embodiments have been set forth in the foregoing description, together with details of the structures and functions of the embodiments, the disclosure is illustrative only; and that changes may be made in detail, especially in matters of shape, size, and arrangement of parts within the principles of the embodiments to the full extent indicated by the broad general meaning of the terms in which the appended claims are expressed.

What is claimed is:

1. A light-emitting device comprising:
a substrate comprising a first surface and a second surface opposite to each other;
at least one first light-emitting member mounted on the first surface of the substrate, the at least one first light-emitting member emitting first light having a first color temperature;
at least one second light-emitting member mounted on the first surface of the substrate, the at least one second light-emitting device emitting second light having a second color temperature;
wherein the second color temperature is higher than the first color temperature, the first light mixing with the second light to produce a light having a wider range of color temperature.

2. The light-emitting device of claim 1, wherein the first light is white light with a light color temperature no more than 9000K.

3. The light-emitting device of claim 2, wherein the first color temperature is ranged from 2300K to 9000K.

4. The light-emitting device of claim 3, wherein the at least one first light-emitting member comprises an LED chip and at least one kind of phosphor layer cooperating with the LED chip.

5. The light-emitting device of claim 1, wherein the second color temperature is no less than 9000K.

6. The light-emitting device of claim 5, wherein the second color temperature is ranged from 9000K to 20000K.

7. The light-emitting device of claim 5, wherein the at least one second light-emitting member comprises an LED chip, and a wavelength of light emitted by the LED chip is no more than 470 nm.

8. The light-emitting device of claim 5, wherein the at least one second light-emitting member comprises a blue LED chip and a phosphor layer cooperating with the blue LED chip, and a color temperature of the second light emitted by the second light-emitting member is ranged from 9000K to 20000K.

9. The light-emitting device of claim 8, wherein the at least one second light-emitting member comprises at least one kind of phosphor.

10. The light-emitting device of claim 8, wherein the blue LED chip of the at least one second light-emitting member is made of semiconductor chosen from a group comprising SiC, ZnO, AlGaInN, and MgZnSeS.

11. The light-emitting device of claim 1, further comprising a reflector, an encapsulant and at least one electric assembly, the reflector being mounted on the substrate and defining a chamber therein, the first light-emitting member and the second light-emitting member being received in the chamber, the electric assembly being mounted on the substrate, the first light-emitting member and the second light-emitting member being electrically connected with the electric assembly, and the encapsulant being received in the chamber of the reflector and covering the first light-emitting member and the second light-emitting member.

12. The light-emitting device of claim 11, wherein the at least one electric assembly comprises two electric assemblies, each of the two electric assemblies comprises a first electrode and a second electrode electrically insulated from each other, the first light-emitting member is mounted on one of the two electric assemblies, two electrodes of the first light-emitting member are respectively connected to the first electrode and the second electrode of the one of the two electric assemblies, the second light-emitting member is mounted on the other one of the two electric assemblies, and two electrodes of the second light-emitting member are respectively connected with the first electrode and the second electrode of the other one of the two electric assemblies.

13. The light-emitting device of claim 12, wherein the two electric assemblies provide the first light-emitting member and the second light-emitting member with different currents.

14. The light-emitting device of claim 11, further comprising a clapboard mounted in the chamber of the reflector, wherein the clapboard divides the chamber of the reflector into two sub-chambers respectively receiving the first light-emitting member and the second light-emitting member therein.

15. The light-emitting device of claim 11, wherein the substrate defines a concave in the first surface, the at least one electric assembly comprises one electric assembly, the electric assembly comprises a first electrode, a second electrode and a heat conductive block, the heat conductive block is embedded in the a bottom of the concave, the first light-emitting member is mounted on the heat conductive block, the first electrode and the second electrode are symmetric with each other relative to the first light-emitting member, and each of the first electrode and the second electrode extends from the bottom of the concave to the second surface of the substrate via the first surface and a lateral side of the substrate.

16. The light-emitting device of claim 11, wherein the first light-emitting member and the second light-emitting are located at different levels in respect of a bottom of the substrate.

17. The light-emitting device of claim 11, wherein the substrate is strip-shaped, the at least one first light-emitting member comprises a plurality of first light-emitting members, the at least one second light-emitting member comprises a plurality of second light-emitting members, and the first light-emitting member and the second light-emitting member are alternately arranged in a line along the substrate.

18. The light-emitting device of claim 17, wherein a ratio between the number of the first light-emitting members and the second light-emitting members is ranged from 1:20 to 20:1.

19. The light-emitting device of claim 11, wherein the at least one first light-emitting member comprises a plurality of first light-emitting members, the at least one second light-emitting member comprises a plurality of second light-emitting members, the first light-emitting members and the second light-emitting members are arranged in an array with a plurality of rows and columns, the first light-emitting members and the second light-emitting members are alternate in each row with a certain number of the first light-emitting members being located between adjacent two second light-emitting members, the second light-emitting members between the adjacent two second light-emitting members and in different columns being in different rows.

20. The light-emitting device of claim 19, wherein a ratio between the number of the first light-emitting members and the second light-emitting members is ranged from 1:20 to 20:1 in a row.
